(19) United States
(12) Patent Application Publication
(10) Pub. No.: US 2012/0276283 A1
(43) Pub. Date: Nov. 1, 2012

(54) ARTICLE CARRIER WITH NON-ADHERENCE COATING

(75) Inventors: Alexander Jittu, Chesterfield, MI (US); Daniel J. Birchmeier, Fenton, MI (US)

(73) Assignee: DESIGNS SYSTEMS INC., Farmington Hills, MI (US)

(21) Appl. No.: 13/097,461

(22) Filed: Apr. 29, 2011

(51) Int. Cl. B05D 5/12; C25D 17/06; B05D 3/00; B05C 13/02; B05D 5/00

(52) U.S. Cl. 427/58; 118/500; 427/256; 204/297.01

(57) ABSTRACT

A non-adherence coating is applied to portions of article carriers used in paint and coating operations to prevent the adherence of paint, undercoat or other coatings applied to the articles from accumulating on the carrier and requiring high pressure fluid streams to remove the accumulated paint and coatings. Article contact surfaces on the carrier frames are left uncovered. Substantially all of the remaining portions of the carrier frames are coated with the non-adherence coating which can be fluoropolymer. The non-adherence coating can be a fluropolymer, such as tetrofluropolyethylene. A method of cleaning the article carrier from accumulated but non-adhered paint and/or undercoat uses a low pressure fluid stream.

### BACKGROUND

The present disclosure relates, in general, to article carriers for supporting articles during painting and coating applications and, more particularly, to vehicle body carriers.

Numerous articles, such as appliances, vehicle bodies, whether made of metal or plastic, are frequently coated with an initial undercoat of primer or rust proofing material, which is then the covered by one or more layers of paint and overcoat material. The undercoating operation can involve a tank through which successive article carriers suspended from a moving conveyor move the articles as the conveyor moves through the undercoating area. The undercoating operation typically applies the undercoat to the article by dipping the entire article in a tank or, for smaller articles, spraying the undercoat onto the article.

One or more layers of paint and an overcoat or clear coat are typically sprayed onto the article as the articles are conveyed by a conveyor through a closed paint booth.

The article carriers, particularly for larger articles, such as vehicle bodies, have multiple article locators or contact points which stationarily and securely positions the article on the carrier. In the case of electro-coating applications, one or more article contacts are provided on the carrier to apply an electric charge to the article.

Such article locator surfaces and electro-coating contacts are not painted or coated in order to present a bare metal or plastic surface for precise article location and support and, in the case of electro-coating, good electrical contact to the article. The remaining surfaces of the article carriers, however, are exposed to the coating and painting operations which cause minute amounts of paint or undercoat to build up on the article carriers.

The material buildup on the article carriers creates several problems. The accumulating material adds to the weight of the carrier and, since multiple carriers are driven by a single conveyor, stress is applied to the entire conveyor and, in particular, to the conveyor drives system. Drips from the carrier can contaminate the downstream article assembly areas in a manufacturing plant.

These problems require the frequent need to remove the accumulated build up of paint, overspray and undercoat on each article carrier. Typically, a high pressure water spray paint at 20,000 psi is used to blast accumulated paint and undercoat build up from the carriers. This is dangerous to personnel, messy and has a high cost due to the higher capacity pumps and equipment used to generate high-pressure stream.

A large area is also required for the cleaning operation due to the longer distance paint splatter created by the high-pressure stream can travel.

Such cleaning operations are typically done during non-assembly times between work shifts or on weekends. Both of these time periods are typically premium worker time. Alternately, additional carriers may be required to enable one or more carriers to be removed from the assembly line for cleaning and simultaneously replaced by clean carriers to prevent any stoppage of the assembly line.

It would be desirable to provide an article carrier as well as a method of making and using an article carrier that addresses these problems.

### SUMMARY

An article carrier for supporting an article during a coating application includes a carrier frame, with at least one article contact surface and at least one non-article contact surface on the carrier frame. A coating of a material having non-adherence properties for coatings applied to an article carried on the carrier frame is applied to selected surfaces, such as to the at least non-article contact surface on the carrier.

The non-adherence properties of the coating applied to the carrier frame prevents adherence of coating material applied to the article carried on the carrier frame to the carrier frame.

The at least one article contact surface on the carrier frame includes an electrical conductor contacting the article during an electro-coating application.

In one aspect, the non-article contact surface includes substantially the entire carrier frame excluding all article contact surfaces.

The non-article contact surface to which the coating with non-adherence properties is applied can include all portions of the carrier frame exposed to article coatings during the application of coatings to an article carried on the carrier frame.

In one aspect, at least one article contact surface includes a plurality of article contact surfaces, and the at least one non-article contact surface includes substantially all of the carrier frame excluding all of the article contact surfaces.

The coating of non-adherence material can be a fluropolymer. In one aspect, the fluropolymer is tetrafluropolyethylene.

A method of making an article carrier for supporting an article during an article coating application comprising the steps of:

providing a carrier frame; and

applying a coating of a material having non-adherence properties for coatings applied to an article carried on the carrier frame to selected surfaces on the carrier frame.

The method can also include the step of providing the non-adherence properties of the coating applied to the carrier frame to prevent adherence of all coatings applied to the article while the article is carried on the carrier frame to the carrier frame.

The method can also include the step of forming the at least one article contact surface on the carrier frame and an electrical conductor contacting the article during an electro-coating application.

In one aspect of the method, the at least one non-article contact surface includes substantially the entire carrier frame excluding all article contact surfaces.

In one aspect of the method, the at least one non-article contact surface to which the coating with non-adherence properties is applied may include all portions of the carrier frame exposed to article coatings during the application of coatings to an article carried on the carrier frame.

The method can also include the at least one article contact surface formed of a plurality of article contact surfaces and the at least non-article contact surface formed of substantially all of the carrier frame excluding all of the article contact surfaces.

The method further comprises the step of forming the coating of a material having the non-adherence properties of a fluropolymer. The coating of the material having non-adherence properties can be tetrafluropolyethelene.

A method of using an article carrier having a carrier frame with at least one article contact surface for supporting an article on the carrier frame and at least one non-article contact surface on the carrier frame, comprising the steps of coating the at least one non-article contact surface with a coating of a material having non-adherence properties for coatings applied to an article carried on the carrier frame.

The method further comprises the step of forming the material with non-adherence properties of a fluoropolymer. The method further comprises the step of forming the fluoropolymer of tetrafluoropolyethylene.

The method can further comprise the steps of forming the at least one article contact surface on the carrier frame as a plurality of article contact surfaces, and forming the at least one non-article contact surface on the carrier frame as substantially all of the carrier frame excluding the plurality of article contact surfaces.

The method can further include the step of forming at least one article contact surface as an electrical conductor contacting an article on the carrier frame during an electro coating application.

The method can further comprises the step of periodically removing any accumulation of article coatings from the article carrier frame by use of a low pressure fluid stream directed at the carrier frame. The low pressure fluid stream can be a low pressure water stream. The low pressure water stream can be a low pressure water stream of less than or about 150 psi.

### BRIEF DESCRIPTION OF THE DRAWING

The various features, advantages and other uses of the present article carrier with non-adherence coating will become more apparent by referring to the following detailed description and drawing in which:

FIG. 1 is a end elevational view of a robotic paint booth;

FIG. 2 is a plan view of the floor of the paint booth shown in FIG. 1;

FIG. 3A is a perspective view of one example of an inverted power and free article carrier;

FIG. 3B is an enlarged view of one article locator detail on the article carrier shown in FIG. 3A;

FIG. 4 is a perspective view of another example of a paint carrier;

FIG. 5 is a perspective view of a paint skid carrier;

FIG. 6 is a perspective view of another example of a paint skid carrier;

FIG. 7 is a perspective view of an ELPO undercoat carrier;

FIG. 8 is the side elevational view of another aspect of an article carrier for smaller articles;

FIG. 9 is a side elevational view of the article carrier shown in FIG. 7; and

FIG. 10 is a pictorial representation of a cleaning operation for an article carrier.

### DETAILED DESCRIPTION

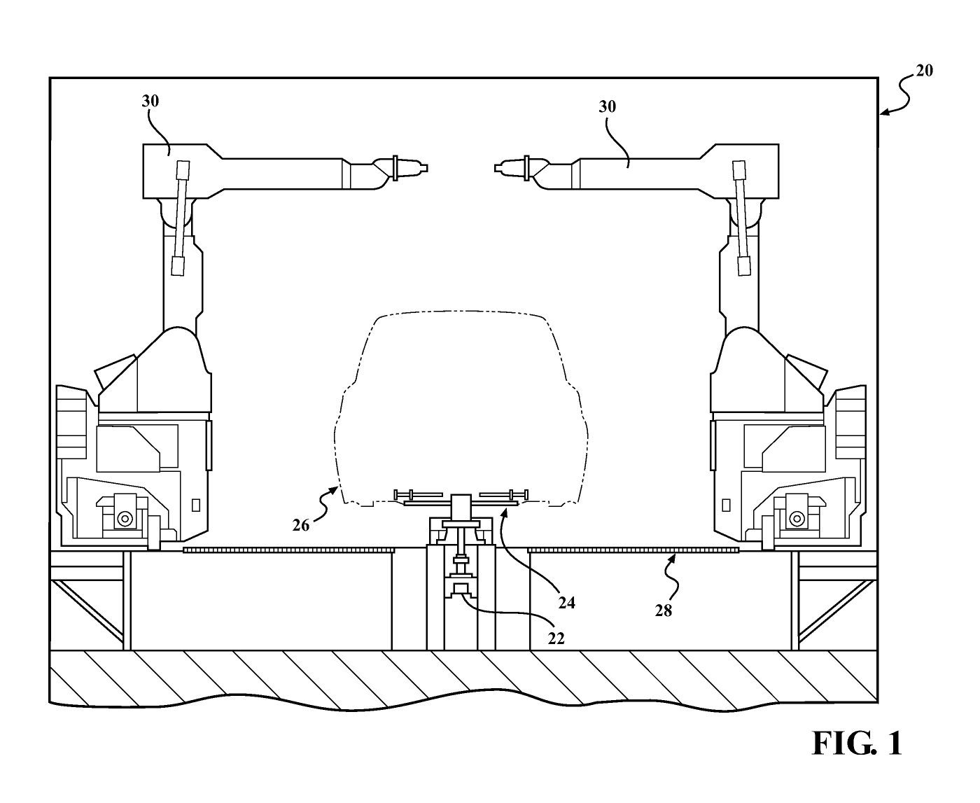

Referring now to FIGS. 1-8, there are depicted various aspects or examples of diverse article carriers used to support and transport articles through a painting or coating application.

It will be understood that although many of the following examples of an article carrier are specific to automotive vehicle body carriers, the present method and apparatus can be used with any carrier used to support any article in a paint or coating application, regardless of whether the carrier transports the article through the painting or coating operation or is stationary during the painting or coating operation.

The article carriers disclosed herein are employed for supporting and transporting vehicle bodies through a paint booth 20 shown by way of example only in FIG. 1. The paint booth 20 is a closed clean area through which a conveyor 22 moves. The conveyor 22 supports a plurality of article carriers 24 located at substantially equal intervals along the length of the conveyor 22. As explained above, the carrier 24 supports a vehicle body 26 by way of example only as one type of article.

Grates 28 are located above the floor of the paint booth 20 to allow overspray to pass from the interior of the booth into collection trays or troughs located underneath the grates 22 on or above the bottom of the paint booth 20.

One or more paint applicators 30 which, in this example, are in the form of robotic paint applicators, are positioned along the length of the paint booth 20 and spray paint over portions of the article or vehicle body 26.

In the following article carrier configurations, a non-adherence material coating is provided on selected areas of the article carrier, such as on selected article support members or portions thereof which are in direct contact with the article or vehicle body for example. Portions of the article support assembly adjacent to the bare metal contact surfaces will be provided with the non-adherence coating to prevent build up of paint or undercoat on the article support members which may accumulate to such an extent that it interferes with the mounting or removal of the vehicle body to or from the carrier.

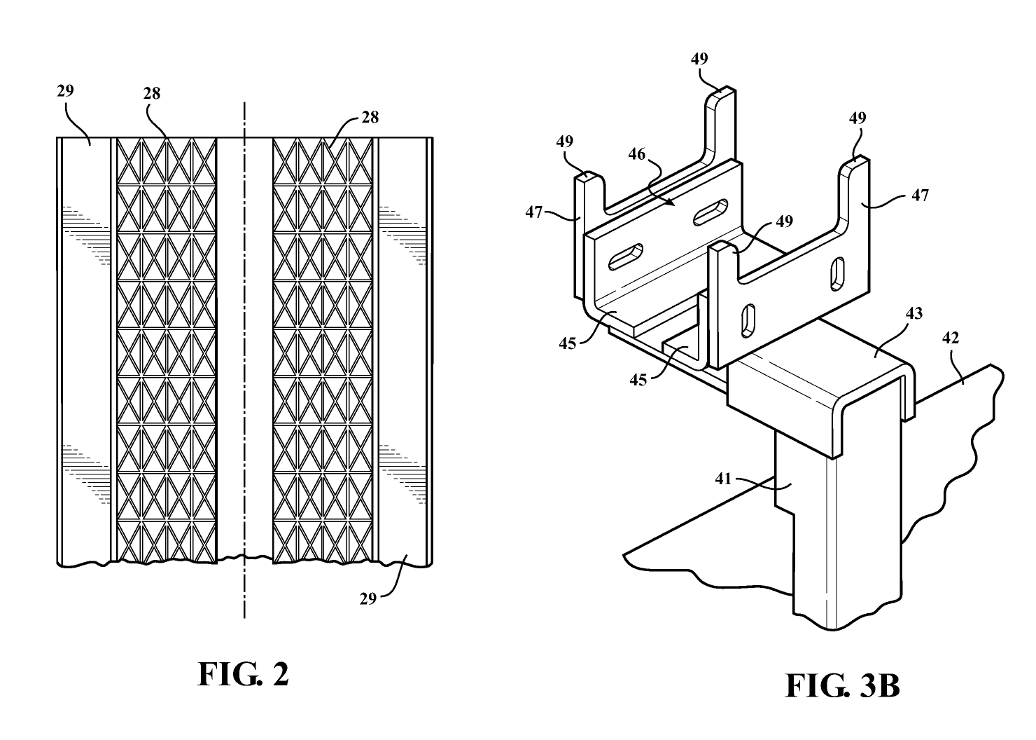

Additional surfaces may also be coated with the non-adherence coating. For example, as shown in FIG. 2, the grates 28 along the bottom booth 20 may be coated with a non-adherence coating to prevent the attachment and excessive build-up of paint or coating overspray on the surfaces of the grates 28. In addition to the open grates 28, adjacent floor surfaces 29, may also be coated with a non-adherence coating, particularly those surfaces 29 over which the robotic paint applicator's 30 traverse during a paint or coating cycle.

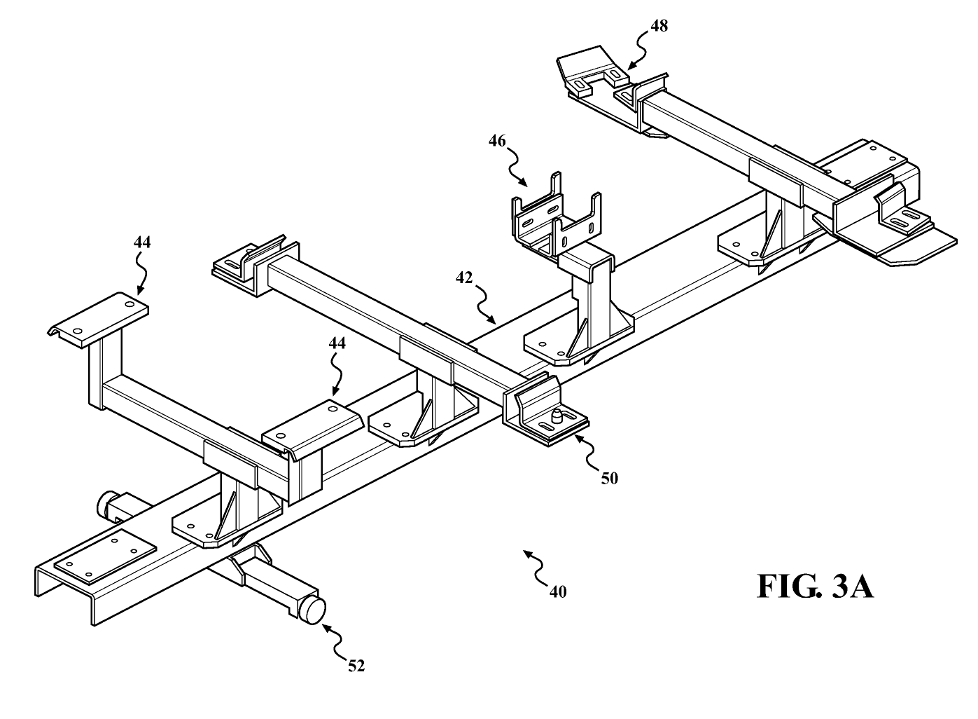

As shown in a first example of an article carrier 40 in FIG. 3A, the article carrier 40 includes a rigid carrier frame 22, typically formed of metal; but other materials, such as plastic, etc., can also be employed for the entire or only selected portions of the carrier frame 42. At least one and, typically, a plurality of article contact surfaces 44, 46 and 48 are rigidly and stationarily mounted on the carrier frame 42 for contacting, supporting and locating different portions of the article or vehicle body.

For example only, the article contact surfaces 44 define a product support detail or surface. The contact surface 46 defines a fore/aft locator. The contact surfaces 48 define further article support details.

Article contact surfaces 50 define article support surfaces for side to side location of the vehicle body on the carrier frame 22. Frame stabilizer wheels 52 are provided on at least the forward end of the carrier frame 42 to stabilize the frame 42 as it moves through the paint booth. The wheels 42 contact guide rails or other surfaces, not shown, within the paint booth 20.

According to one example, the one or more article contact surfaces 44, 46, 48, 50 and the stabilizer wheels 52 also included as contact members, typically are provided without an exterior protective coating to present bare metal or plastic for precise contact and location of the vehicle body on the carrier frame 42 as well as engagement of the carrier frame 42 with surrounding guide members in the paint booth 20. The remaining portions of the carrier frame 42 define non-article contact surfaces.

As shown in FIG. 3B, the article contact surface 46, which defines a fore/aft locator, includes, by example only, a support 41 fixedly mounted on and extending upward from the frame 42. The support 41 has an upper leg 43 which serves as a base for a pair of mounts 45.

The mounts 45 are fixedly attached to the leg 43 by suitable fastening means, such as fasteners, welding, etc. A plate 47 is attached, by adjustable fasteners, to each mount 45. Each plate 47 includes one or more article contact projections which engage surfaces or apertures in the article or vehicle body to precisely locate and position the article or vehicle body on the article carrier 40 during the painting or coating operation.

The non-adherence coating may be applied to various portions of the locator 46. For example, the non-adherence coating may be provided solely on the article locating projections 49. Alternately, the non-adherence material coating can be provided on the entire exposed surfaces of the plates 47 and/or or the mounts 45 and/or part of or the entire support leg 43.

During a painting operation in which the paint is applied by the robot applicators 30 as a spray onto the exposed surfaces of the vehicle body 26, overspray, which does not contact the vehicle body 24, is common. Although the robotic applicators 30 precisely spray the paint onto to the vehicle body 26 to minimize overspray, overspray is common due to the irregular shape of the vehicle body. Such overspray can accumulate on any exposed non-article contact surface of the carrier frame 42, such as the support structure of the carrier frame 42 supporting the article contact surfaces 44, 46, 48 and 50, as well as the support members for the stabilizer wheels 52.

Although the stabilizer wheels 52 do not contact the article or vehicle body 26, the wheels 52 do roll along a guide rail or contact surface within the paint booth 20 and must be free of accumulated paint or overspray to enable free rotation.

Any overspray that does exist will not contact the article contact surfaces 44, 46, 48 and 50 since they are typically covered by the vehicle body 26 in a spray painting application. The remaining portions of the carrier frame 42 as well as the stabilizer wheels 52 are exposed to overspray and can and will accumulate a build up of paint overspray during repeated passes of the carrier frame 42 through the paint booth 20.

In order to minimize the build up of paint overspray on the exposed non article contact surfaces of the carrier frame as well as the stabilizer wheels 52 and other critical parts of the carrier frame 42, a protective coating formed of a material which prevents non-adherence of the paint or other coatings applied to the vehicle body carried on the article carrier 42 is applied to all exposed surfaces of the carrier frame 42, and/or non-article contact surfaces including the stabilizer wheels 52.

The material coating is provided in a suitable thickness to minimize wear during use of the article carrier as well as cleaning operations of the article carrier 42 as described hereafter.

By way of example, the material coating is formed of a fluoropolymer, such as a fluoropolymer of tetrafluoroethylene, sold commercially by Dupont under the trademark TEFLON. Other non-limiting examples of fluropolymers include fluorinated ethylene propylene copolymer, perfluoropropylene-vinyl-ether and perfluoroalkosxy.

The material coating is applied to selected surfaces, such as the non-article contact surfaces of the carrier frame 42, by spraying, electro-deposition, brushing, dipping, etc., depending upon the carrier configuration and the optimum method to apply the coating to a particular surface on the carrier.

The surface to be coated with non-adherence material coating is initially cleaned in preparation for the coating application.

Alternately, the carrier surface can be roughened, by etching with acid, for example. After application of the material coating, the material coating can be dried in an oven to insure fixed adherence to the carrier surface. Optionally, the applied fluoropolymer coating can also be sintered and cooled for secure adherence to the selected surfaces on the carrier.

After repeated passes of each article carrier 42 through the paint booth 20, it is inevitable that certain non contact article surfaces of the carrier frame 42 will have an accumulation or build up of paint, even though the non-adherence coating prevents adherence of the paint to the carrier frame 42. In order to remove such accumulations of paint from the carrier frame 42, the carrier frame 42 passes through a cleaning area, shown in FIG. 9 in which a low pressure fluid stream, such a low pressure water stream of less than or about 150 psi, is directed onto the article carrier 40 when the article carrier 40 is not supporting a vehicle body 26. The high pressure spray which can be robotically directed toward the article carrier 42 or manually directed by an operator to blast the accumulated, but not adhered paint from the article carrier 40.

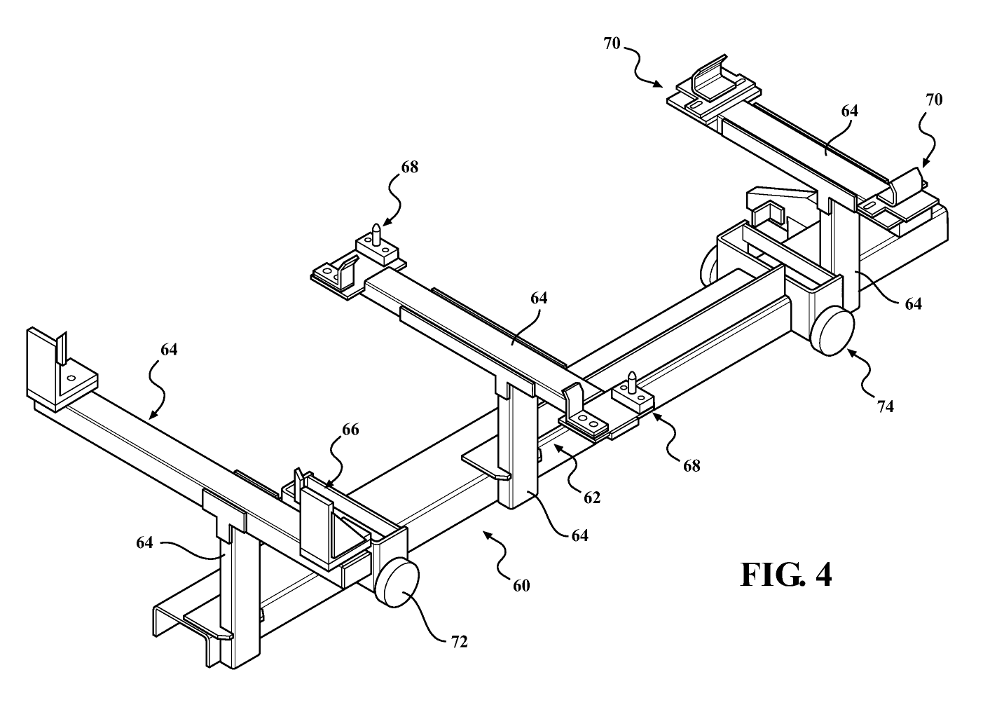

Referring now to FIG. 4, there is depicted another aspect of an article carrier 60. Like the article carrier 40, the article carrier 60 includes a frame 62 including supports 64 for a plurality of product support or article contact surfaces 66, 68 and 70. Pairs of stabilizer wheels 72 and 74 are mounted on the frame 62 and engage guide surfaces, not shown, within the paint booth.

As with the article carrier 40 shown in FIG. 2, in the article carrier 60, the article contact surfaces 64, 68 and 70, as well as the stabilizer wheels 72 are not coated or covered with any type of protective paint layer. Such surfaces remain free of paint or coatings for proper vehicle body location and guidance of the article carrier 60 through the paint booth 20. All of the remaining portions of the carrier frame 62, including the support 64, will be exposed to paint overspray and will be covered by the non-adherence material coating described above.

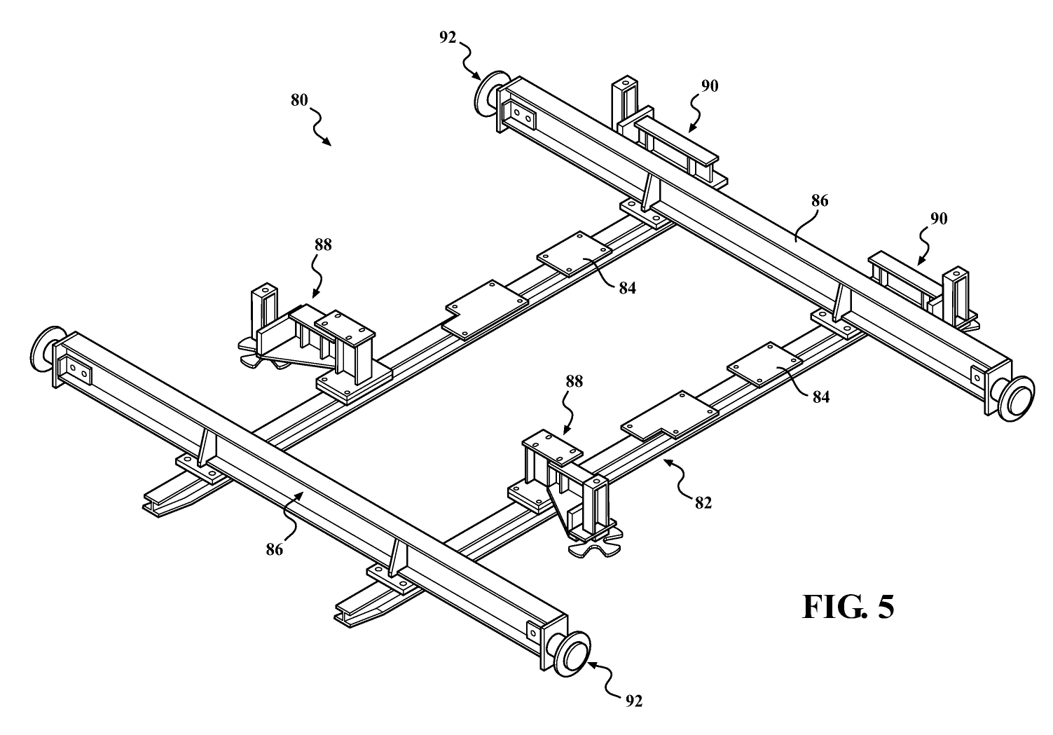

Another aspect of an article carrier 80 is shown in FIG. 5. The article carrier 80 includes a large frame 82 which functions as an article skid. The frame 82 includes longitudinally extending frame members 84 and cross-wise extending fore and aft frame members 86.

Article contact surfaces or support members 88 and 90 are mounted on the frame members 84 or 86. The article contact surfaces or support members 88, or at least a portion thereof which contacts the vehicle body, remain free of paint. The remaining portions of the article support members 88 and 90, as well as the entire frame 82, including the frame members 84 and 86, are covered with the non-adherence material coating described above.

Outriggers 92 at the ends of the cross-wise extending frame members 86 are also a no-paint area and will be provided with a coating of the non-adherence material.

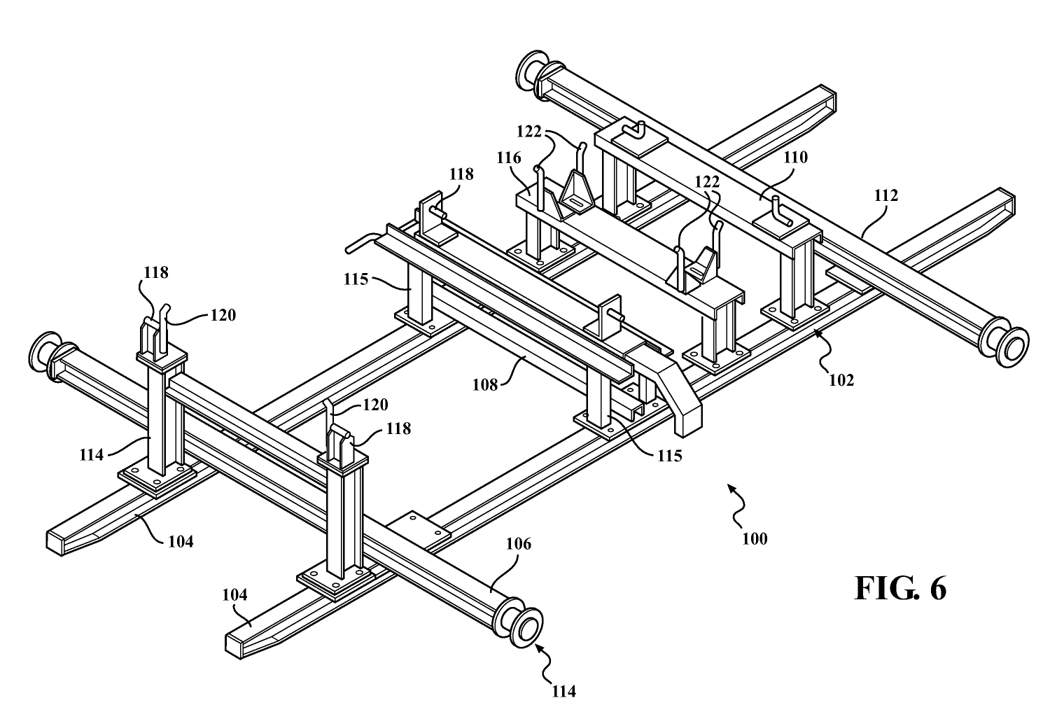

FIG. 6 depicts yet another aspect of an article carrier 100. The article carrier 100 includes a carrier frame 102 formed of longitudinally extending rails 104 and a plurality of cross-members 106, 108, 110 and 112, for example. Outriggers 114 are mounted on the ends of the cross members 106 and 112 to guide the article carrier 100 through the paint area.

Vertical and horizontally extending supports 114, 115 and 116 are mounted on the rails 104 and support article contact surfaces or elements 118. As shown in FIG. 6, the supports 114 and 116 also carry one or more contact members 120 and 122. The contact members 120 and 122 provide a secure electrical connection between the article carrier frame 102 and the vehicle body to enable an electrical charge to be supplied through the frame to the body during electro-coating applications.

The supports 114 and 116 thus serve the dual function of supporting the vehicle body on the carrier frame 102 as well as providing a mounting location for the contact elements 120 and 122.

All portions of the frame 102, excluding an article contact surfaces 114, 116, 120 and 132, are covered with the non-adherence material coating

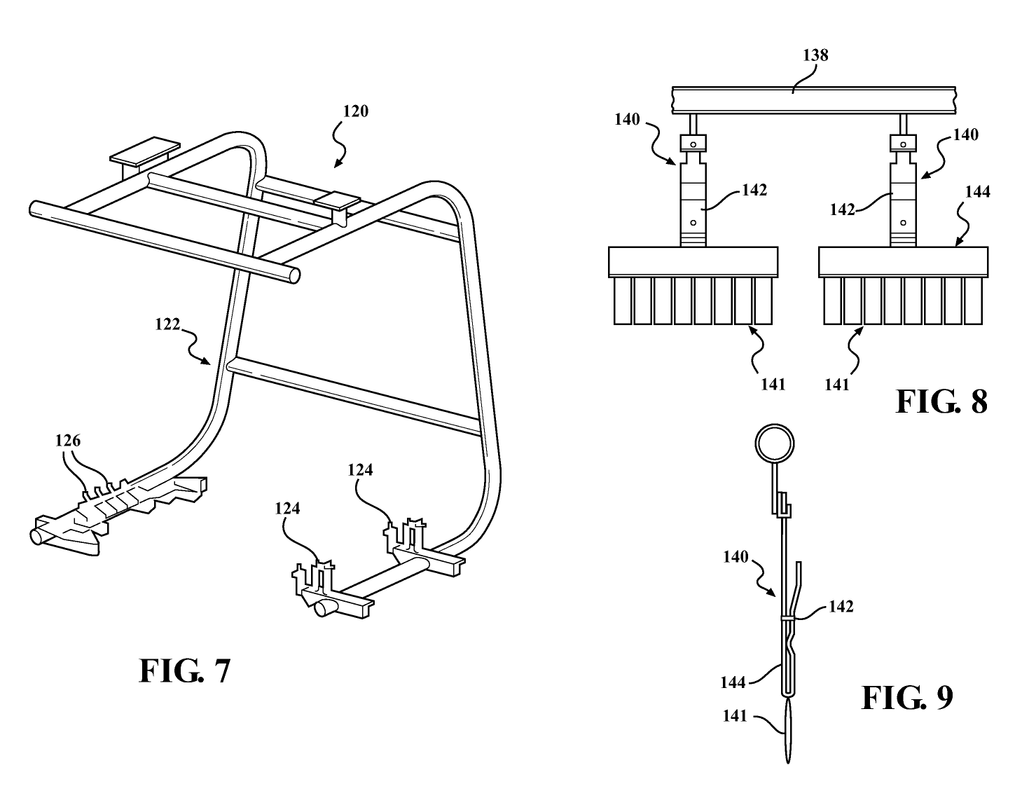

FIG. 7 depicts yet another example of an article carrier 120 designed for supporting an article, such as a vehicle body, during the application of an undercoat, such as a primer, ELPO, etc., to the vehicle body. Such a coating is typically provided in a dip process where the entire vehicle body and substantially all of the carrier frame 122 are dipped into a tank of liquid undercoat material.

The carrier frame 122 includes a frame structure which partially surrounds at least the top, one side and the bottom of the vehicle body, with the vehicle body supported on a bottom portion of the frame by a plurality of body support or contact surfaces 124 and 126.

As the top of the vehicle body will be located in close proximity to the top of the carrier frame 122, substantially all of the carrier frame 122 will be dipped in and covered by the liquid undercoat material. Thus, substantially all of the carrier frame 122 is provided with a non-adherence coating.

Referring now to FIGS. 8 and 9, there is depicted another aspect of an article carrier 140 which is suited for supporting small articles 141 during painting or undercoat operations. The article carriers 140 are supported from a moving conveyor 138. Each article carrier 140, by way of example only, includes a pivotal clamp 142 which has an open and closable ends 144 for grasping and releasing one or more articles 141.

In this aspect, substantially all of the article carrier 140, which can also be referred to as a hanger, and most of the clamp 142, excluding the closable ends 144 which contact the articles 141, are covered with the non-adherence material coating. Depending upon the length of the hanger of each article carrier 140, only a portion of the article carrier or hanger 140 need be covered with the non-adherence coating depending upon the manner in which the paint and/or overcoat is applied to the article. In operations which create only a minimal amount of overspray, only the portions of the article carrier or hanger 140 adjacent to the clamp 142 and one end of the article 141 need be provided with the non-adherence coating.

The entire carrier 140, including the clamp 142 and the clamp ends 144 to be coated with a non-adherence coating. This would prevent buildup of paint or undercoat on the clamp ends 144 which could interfere with proper engagement with the articles 141. It is also possible for the article contact points at the ends 144 of the clamp 142 to be bear metal and not coated with the non-adherence coating.

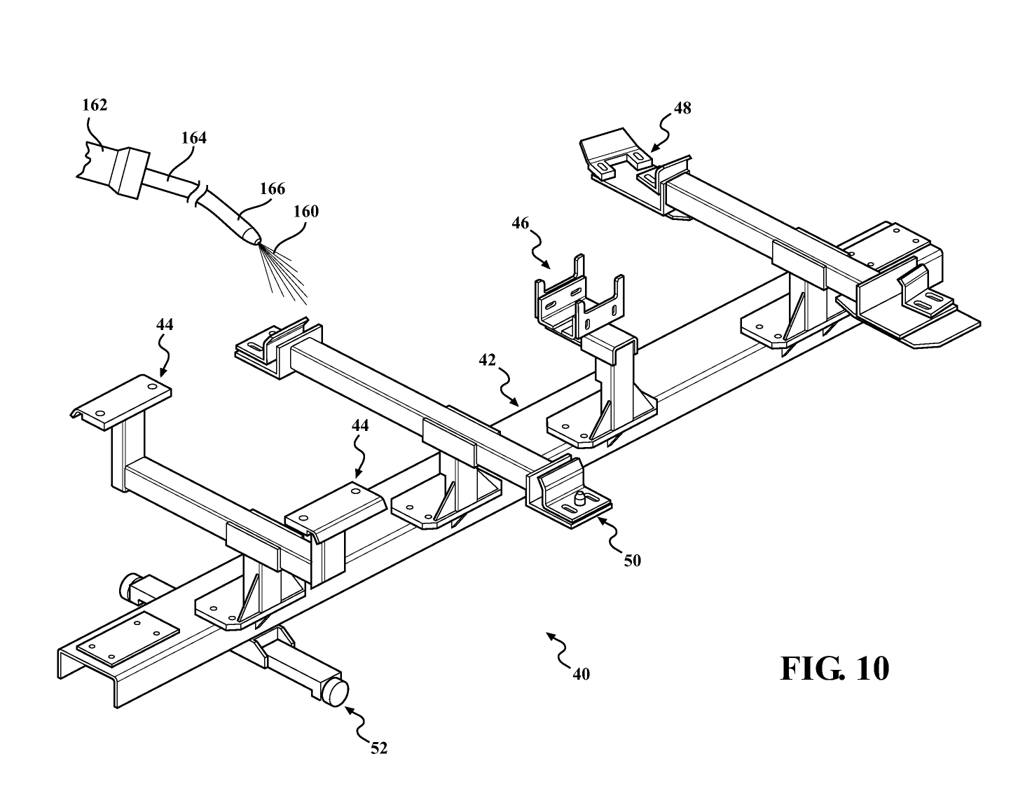

Referring now to FIG. 10, there is depicted a representation of a cleaning operation used to clean any of the article carriers described above, such as article carrier 40. The article carrier 40 is first moved to a cleaning area, which can be separate from the paint booth 30, undercoat area or detached from the main article carrier drive conveyor or in a non-working area of the conveyor system. A low pressure fluid stream 160, which can be a water stream at less than or about 150 psi, is directed from a pressurized fluid source 162 through a delivery line or conduit 164 through a nozzle 166 which is directed to all exposed surfaces of the carrier 40. The low pressure fluid stream 160 removes any paint or undercoat material which has accumulated on the carrier 20, but which is not affixedly adhered to the carrier 20 due to the presence of the non-adherence coating. The accumulated paint or undercoat material is easily removed by the low pressure fluid stream 160. At the same, the non-adherence coating resists the force of the low pressure stream 160 and remains fixed on the article carrier 20.

The low pressure fluid stream can also be used in the paint booth 20, shown in FIGS. 1 and 2, to remove any non-attached paint or coating buildup on the grates 28 and adjacent paint booth floor surfaces 29.

What is claimed is:

1. An article carrier for supporting an article during a coating application comprising:
a carrier frame; and
a coating of the material having non-adherence properties for coatings applied to an article carried on the carrier frame applied to selected surfaces of the carrier frame.

2. The article carrier of claim 1 wherein:
the non-adherence properties of the coating applied to the carrier frame prevents adherence of coatings applied to the article while the article is carried on the carrier frame from adhering to the carrier frame.

3. The article carrier of claim 1 further comprising:
at least one article contact surface on the carrier frame;
at least one non-article contact surface on the carrier frame; and
the material coating applied to the at least one article contact surface on the carrier frame.

4. The article carrier of claim 3 wherein:
the non-article contact surface includes substantially all of the carrier frame excluding any article contact surfaces.

5. The article carrier of claim 3 wherein:
the non-article contact surface to which the coating with non-adherence properties is applied comprises all portions of the carrier frame exposed to the application of coatings to an article carried on the carrier frame.

6. The article carrier of claim 3 wherein:
the at least one article contact surface comprises a plurality of article contact surfaces; and
the at least one non-article contact surface includes substantially all of the carrier frame excluding all of the article contact surfaces.

7. The article carrier of claim 3 wherein:
the at least one article contact surface on the carrier frame includes an electrical conductor contacting the article during an electro-coating application.

8. The article carrier of claim 3 wherein:
the carrier frame is a vehicle body carrier frame;
the at least one article contact surface on the carrier frame defining at least one vehicle contact surface; and
the at least one non-article contact surface on the carrier frame defining at least one non-vehicle contact surface.

9. The article carrier of claim 1 wherein the material having non-adherence properties comprises:
a fluropolymer.

10. The article carrier of claim 9 wherein:
the fluropolymer is tetrafluropolyethelene.

11. A method of making an article carrier for supporting an article during an article coating application comprising the steps of:
providing a carrier frame; and
applying a coating of a material having non-adherence properties for coatings applied to an article carried on the article frame to the selected surfaces of the carrier frame.

12. The method of claim 11 further comprising the step of:
providing the non-adherence properties of the coating applied to the carrier frame to prevent adherence of coatings applied to the article while the article is carried on the carrier frame from adhering to the carrier frame.

13. The method of claim 13 further comprising the steps of:
forming at least one article contact surface on the carrier frame;
forming at least one non-article contact surface on the carrier frame; and
applying the material coating to the at least one article contact surface on the carrier frame.

14. The method of claim 13 further comprising the step:
forming the at least one article contact surface on the carrier frame as an electrical conductor contacting the article during an electro-coating application.

15. The method of claim 13 wherein:
the at least one non-article contact surface includes substantially all of the carrier frame excluding all article contact surfaces.

16. The method of claim 13 wherein:
the at least one non-article contact surface to which the coating with non-adherence properties is applied includes all portions of the carrier frame exposed to article coatings during the application of coatings to an article carried on the carrier frame.

17. The method of claim 13 wherein:
the at least one article contact surface comprises as plurality of article contact surfaces; and
the at least one non-article contact surface includes substantially all of the carrier frame excluding all of the article contact surfaces.

18. The method of claim 11 further comprising the step of:
forming the coating of the material having non-adherence properties of a fluropolymer.

19. The method of claim 18 wherein:
the coating of the material having non-adherence properties is tetrafluropolyethelene.

20. A method of using an article carrier having a carrier frame with at least one article contact surface for supporting an article on the carrier frame and at least one non-article contact surface on the carrier frame, the method comprising the steps of:
coating the at least one selected surface on the carrier frame with a material having non-adherence properties for coatings applied to an article carried on the carrier frame.

21. The method of claim 20 further comprising the step of:
forming the non-adherence material coating of a fluoropolymer.

22. The method of claim 21 further comprising the step of:
forming the fluoropolymer of tetrafluoropolyethylene.

23. The method of claim 20 further comprising the step of:
forming the at least one article contact surface on the carrier frame as a plurality of article contact surfaces; and
forming the at least one non-article contact surface on the carrier frame as substantially all of the carrier frame excluding the plurality of article contact surfaces.

24. The method of claim 20 wherein the step of forming at least one article contact surface comprises the step of:
forming the at least one contact surface as an electrical conductor contacting an article carried on the carrier frame during an electro-coating application.

25. The method of claim 20 further comprising the step of:
periodically removing any accumulation of article coatings from the article carrier frame by use of a low pressure fluid stream directed at the carrier frame.

26. The method of claim 25 wherein the low pressure fluid stream is a low pressure water stream.

27. The method of claim 26 wherein the low pressure water stream is a low pressure water stream of less than or about 150 psi.

28. The method of claim 20 further comprising the steps of:
moving the article carrier through a paint booth having a floor; and
applying the material coating to at least a portion of the floor of the paint booth.

29. The method of claim 28 further comprising the steps of:
applying the material coating to grates in the floor of the paint booth.
